(19) United States
(12) Patent Application Publication
(10) Pub. No.: US 2025/0147179 A1
(43) Pub. Date: May 8, 2025

(54) OPTICAL EDGE POSITION MEASUREMENT FOR ROTATING MACHINERY

(71) Applicant: PHOS GLOBAL ENERGY SOLUTIONS, INC., Fort Lauderdale, FL (US)

(72) Inventors: Eugene Earle Rudolph, Port Jefferson Station, NY (US); Victor Bica, Saint James, NY (US)

(73) Assignee: PHOS GLOBAL ENERGY SOLUTIONS, INC., Fort Lauderdale, FL (US)

(21) Appl. No.: 18/936,418

(22) Filed: Nov. 4, 2024

Related U.S. Application Data
(60) Provisional application No. 63/547,304, filed on Nov. 3, 2023.

(51) Int. Cl. G01S 17/06; G01B 11/02; G01S 7/481

(52) U.S. Cl. CPC G01S 17/06; G01B 11/02; G01S 7/4814; G01S 7/4816

(57) ABSTRACT

An optical sensor system including a light source configured to illuminate an edge of a rotating element, a light filter optically between the light source and the edge of the rotating element, and an optical sensor configured to detect light reflected from the edge of the rotating element, wherein the optical sensor outputs a signal indicative of a location of the edge of the rotating element.

### TECHNICAL FIELD

This disclosure relates generally to optical systems and methods for measurement of changes in dimensions of rotating machinery.

### BACKGROUND

Renewable energy has become an increasingly important source of electrical energy generation in many countries around the world. As the demand for electrical energy has increased, the impact of fossil fuels on the environment has become magnified and increasingly apparent. In an effort to overcome these obstacles, advancements in green energy generation have continued to accelerate, resulting in innovations such as hydrodynamic generators, wind turbines, geothermal energy, biomass energy, amongst others.

However, mechanical energy storage and generation (e.g., flywheels), despite its simplicity, has historically remained rather undeveloped. One challenge associated with flywheels is their weight. For example, exemplary flywheels may weigh between 2000 and 8000 lbs. Not only are the flywheels heavy, but they are spinning at between 4000 and 15000 RPM, with a flywheel having a diameter of 36 to 48 (or more) inches results in the outer edge of the flywheel achieving very high speeds. This combination of weight and speed can test the strength of the materials from which the flywheels are made. As with any rotating machinery, the ability to monitor and assess any changes in the components' during use is important, particularly where the rotating machinery is not easily disassembled or inspected. Accordingly, this disclosure is directed to improved systems and methods of non-invasively assessing the structural integrity of rotating machinery.

### SUMMARY

One aspect of the disclosure is directed to an optical sensor system including a light source configured to illuminate an edge of a rotating element; a light filter optically between the light source and the edge of the rotating element; an optical sensor configured to detect light reflected from the edge of the rotating element, where the optical sensor outputs a signal indicative of a location of the edge of the rotating element. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The optical sensor system further including a lens configured to focus the light emitted from the light source. The light source is a light emitting diode. The optical sensor system further including a polarizer on the light source. The optical sensor system further a polarizer on the optical sensor. The optical sensor includes an array of photo-receptors. The array of photo-receptors includes a series of rows of photo-receptors. Each row of photo receptors is spaced less than about 10 microns a neighboring row of photo-receptors. The array of photo-receptors can resolve a change in dimension of the rotating element of about 0.0001 inch. The rotating element is a flywheel. The difference is indicative of a change in radial dimension of the flywheel. The memory stores therein instructions which when executed by the processor perform a step of stopping rotation of the flywheel when the difference indicative of a change in a longitudinal dimension of the flywheel is in excess of a threshold. The difference is indicative of a change in longitudinal dimension of the flywheel. The memory stores therein instructions which when executed by the processor perform a step of stopping rotation of the flywheel when the difference indicative of a change in the longitudinal dimension of the flywheel is in excess of a threshold. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

A further aspect of the disclosure is directed to an energy storage system including a motor; a flywheel operatively coupled to the motor and including a flywheel enclosure; and an optical sensor system mounted within the flywheel enclosure, the optical sensor system including: a light emitting diode (led) configured to illuminate an edge of the flywheel; a light filter optically between the led and the edge of the flywheel. The system also includes an optical sensor configured to detect light reflected from the edge of the flywheel, where the optical sensor outputs a signal indicative of a location of the edge of the flywheel. Other embodiments of this aspect include corresponding computer systems, apparatus, and computer programs recorded on one or more computer storage devices, each configured to perform the actions of the methods and systems described herein.

Implementations of this aspect of the disclosure may include one or more of the following features. The energy storage system further including a computing device including a memory storing therein instructions that when executed by a processor perform a step of determining a difference between the signal output from the optical sensor to an initial signal, where the difference is indicative of a change in radial dimension of the flywheel. The memory stores therein instructions which when executed by the processor perform a step of stopping rotation of the flywheel when the difference indicative of a change in a longitudinal dimension of the flywheel is in excess of a threshold. The difference is indicative of a change in longitudinal dimension of the flywheel. The memory stores therein instructions which when executed by the processor perform a step of stopping rotation of the flywheel when the difference indicative of a change in the longitudinal dimension of the flywheel is in excess of a threshold. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a partial cross-sectional view of a mechanical energy storage solution;

FIG. 2 is a cross-sectional view of lower portion of a flywheel of the mechanical energy storage solution of FIG. 1;

FIG. 3 is a schematic view of an optical sensor system in accordance with the disclosure; and

FIG. 4 is a schematic view of an optical sensor system in accordance with the disclosure.

### DETAILED DESCRIPTION

Embodiments of the disclosure are now described in detail with reference to the drawings in which like-reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

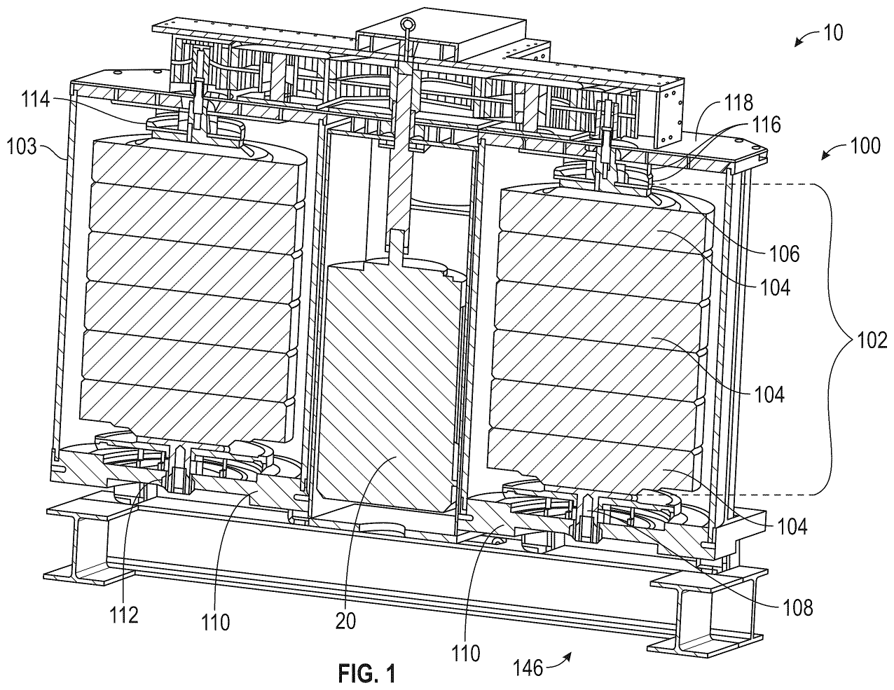

Referring now to the drawings, a mechanical energy storage solution 10 in accordance with the disclosure is illustrated in FIG. The mechanical energy storage solution 10 includes two flywheel assemblies 100, one or more motors 20, and one or more generators (not shown in FIG. 1). Each of the two flywheel assemblies 100 is substantially similar to one another and therefore, only one flywheel assembly 100 will be described in detail herein in the interest of brevity.

The flywheel assembly 100 includes a flywheel 102 and a flywheel enclosure 103. The flywheel 102 includes one or more flywheel segments 104 disposed substantially coaxially upon one another forming a generally cylindrical profile, each flywheel segment 104 defines a generally cylindrical profile having an outer sidewall extending between opposed upper and lower surfaces. Alternatively, it is contemplated that the flywheel 102 may be formed from a single, monolithic piece of material (e.g., billet, casting, forging, etc.). In FIG. 1 the segments 104 are welded together, ground to a generally uniform diameter and then balanced. On the top end of each flywheel 102 a top spindle segment 106 is formed and on a bottom end of each flywheel a bottom spindle segment 108 is formed, the top and bottom spindle segments 106 and 108 enable mechanical coupling of magnetic bearing housings and in the case of the top spindle segment 106 receive a shaft which rotates a pinion gear of a gear train (e.g., a magnetic gear train).

As shown in FIG. 1 the flywheel 102 includes multiple flywheel segments 104, each flywheel segments 104 is disposed in a stacked configuration such that a lower surface of a first flywheel segment 104 abuts or otherwise contacts an upper surface of an adjacent flywheel segment 104. Each flywheel segment 104 is coupled to one another using any suitable means, such as welding, adhesives, fasteners, amongst others. Where welding is employed, each flywheel segment 104 is coupled to one another by laser welding, electron beam welding, etc.

Continuing with FIG. 1, the flywheel 102 is disposed within a flywheel enclosure 103. The flywheel enclosure 103 may be formed of a steel pipe or other suitable material capable of maintaining a deep vacuum (e.g., approaching 0 psi, mm Hg, etc.) when appropriately sealed. The flywheel enclosure 103 mates with a base plate 110 and one or more rubber sealing rings (not shown) may be employed to ensure a substantially air-tight fit between the flywheel enclosure 103 and the base plate 110. A bore 112 in the base plate 110 is configured to receive a portion of the bottom spindle segment 108 and a bearing (e.g., a roller bearing) may be optionally employed in the bore to receive the portion of the bottom spindle segment 108 and take up any lateral forces.

It is envisioned that the base plate 110 may be formed from any suitable material, such as aluminum, steel, stainless steel, tungsten, alloys, composites, polymers, and combinations thereof. In embodiments, the base plate 130 may be formed from the same or different material than that of the flywheel enclosure 103 or flywheel 102. It is contemplated that the base plate 110 may be coupled to the flywheel enclosure 103 using any suitable means, such as fasteners, adhesives, welding, amongst others, and may include a gasket (not shown) or other suitable device capable of forming a vacuum tight seal interposed between the base plate 110 and the flywheel enclosure 103.

Mounted on the top spindle 106 of each flywheel 102 is a magnetic lift bearing 114. As will be explained the magnetic lift bearing 114 is formed of two halves 116. A lower half 116 is secured to the top spindle 106, and an upper half 116 may be secured to a top plate 118 of the flywheel 102. The top plate 118 along with bottom plate 110 complete the flywheel enclosure 103 and form a vacuum tight space in which the flywheel 102 rotates substantially free of friction.

The magnetic lift bearing 114 has a generally circular profile, and may be formed from any suitable material, such as aluminum, steel, stainless steel, tungsten, alloys or combinations thereof. Alternatively, the magnetic lift bearing 114 may be formed entirely from a permanent magnet, such as a ceramic or ferrite magnet, a neodymium magnet, an alnico magnet, an injected molded magnet, a rare earth magnet, a magnetic metallic element, amongst others, although it is contemplated that the magnet may be an electromagnet.

As noted above, the flywheels 102 rotate at between 4000 and 15,000 RPM. At for example 10,000 RPM a point on the outer edge of a flywheel 102 having a diameter of 36 inches, will have a linear velocity of over 1000 MPH. Any steel mass spinning at that speed will generate an incredible centrifugal force. In the flywheel 102 of FIG. 1, that force places the mass of the flywheel in tension. Regardless of the material employed to manufacture the flywheel 102, those forces or stress will cause creep (cold flow) in the flywheel slowly increasing the diameter of the flywheel 102. Where sufficient creep is induced, as with any material placed in tension, at some point the stresses overcome the yield strength of the material and results in failure.

As will be appreciated, monitoring the flywheel to ascertain the effects of continuous spinning at 10,000 RPM, and the changes that result from cycling of the flywheel between, for example, 5,000 and 10,000 RPM (e.g., through a discharge and recharge cycle) is of tremendous value to the operators of the flywheel assemblies 100. Still further, in view of the vacuum environment within the flywheel enclosure 103, and the need to observe the creep during high-speed operations, it is desirable that the observation mechanism be non-contact, and available without requiring opening of the flywheel enclosure 103.

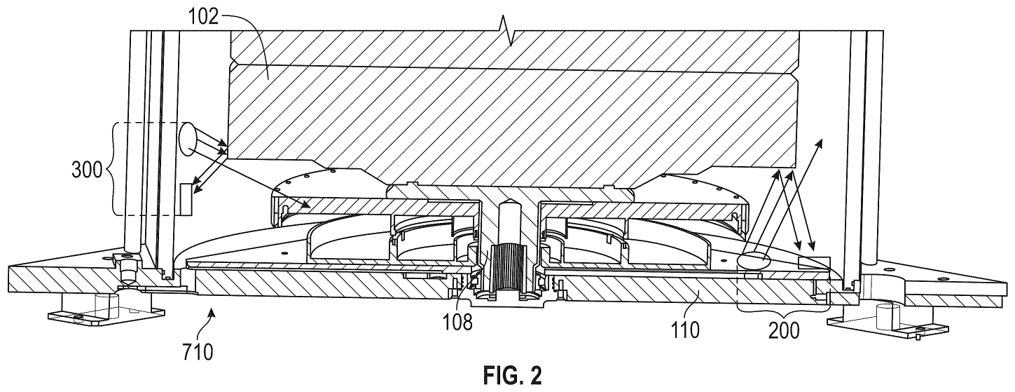

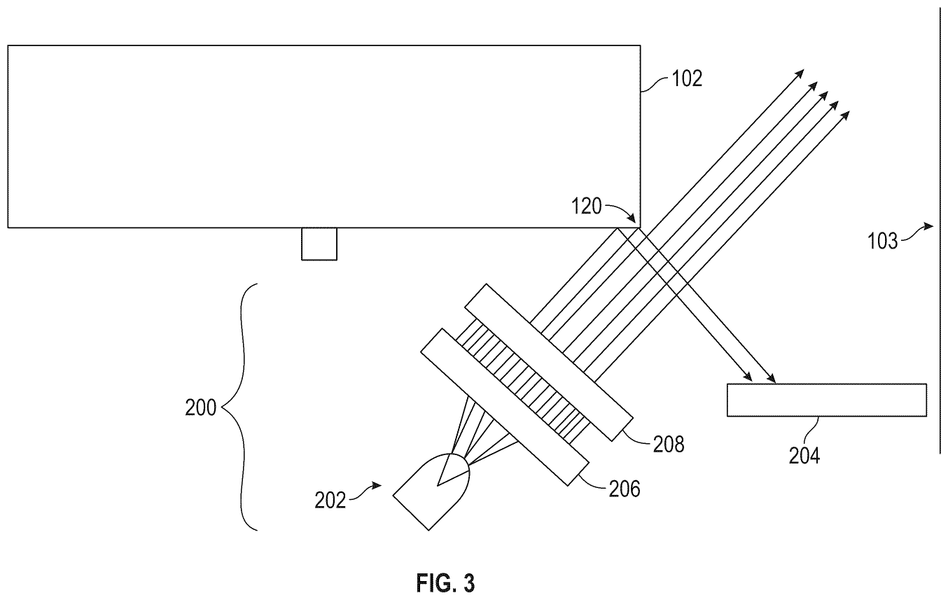

FIG. 2 depicts a view of a bottom portion of the flywheel assembly 100. In addition to the other components described above, an optical sensor system 200 is depicted. As shown and described in greater detail in connection with FIG. 3 a light emitting diode (LED) 202 emits light in the direction of a lower edge 120 of the flywheel 102. Light striking the flywheel 102 reflects and is detected by an optical sensor 204 that is within the flywheel enclosure 103. Light which bypasses the edge 120 of the flywheel 102 is not reflected and thus not detected by the optical sensor 204. By detection of a location on the optical sensor 204 at which the reflected light is detected, any change in the dimensions of the flywheel 102 is detected. In some aspects of the disclosure the LED 202 is a laser diode.

FIG. 3 depicts further details of the optical sensor system 200. As shown the light emanating from the LED 202 passes through a lens 206. The lens 206 may be, for example, a collimating lens or a cylindrical lens. The purpose of the lens 206 is to focus the light beams emanating from the LED in a generally fan like pattern and direct them onto the flywheel 102, where eventually some strike the underside of the flywheel 102. Before striking the flywheel, the light beams must pass through an optical filter 208. The optical filter 208 limits the light beams which have been focused by the lens 206 to allow light to pass through the filter 208 only at selected intervals (e.g., every 0.5 mm) over a certain distance. This effectively reduces the light beams directed at the flywheel 102, and also provides for a uniform dispersion of the light beams. As noted above, the light beams are directed at the underside of the flywheel 102, and any which intersect with the flywheel 102 are reflected from the flywheel 102. Any light beams which do not intersect the flywheel 102 pass by the flywheel and may ultimately strike the flywheel enclosure 103, and are generally dissipated within the flywheel enclosure 103. The light beams which reflect from the underside of the flywheel impact the optical sensor 204. By use of the filter 208, the light beams impacting the flywheel are at set intervals (e.g., every 0.5 mm) and thus the reflected light impacting the optical sensor is also at regular intervals.

The optical sensor 204 may be formed of an array of highly precise bands of photo-receptors (e.g., a series of rows of phot-receptors), each photo-receptor has a precise pitch dimension between successive bands, as an example, less than about 10 microns between neighboring rows of photo-receptors. Thus, the optical sensor 204 can react very quickly to changes in illumination. In some aspects of the disclosure the optical sensor has an electrical response time of about a microsecond. When illuminated by the reflected light beams, the photo-receptors effectively close a circuit, and a signal is generated. Based on, for example, a determined number of rows of photo-receptors that are illuminated by the reflected the signal output from the optical sensor 208 will vary.

That generated signal can be provided to a computing device (not shown). The computing system includes one or more processors, a memory storing one or more applications including instructions, and a user interface. When the instructions are executed by the processors, at least one of the applications can perform steps of calculating based on the signal received from the optical sensor 204, the dimensions of the flywheel 102. The provision of the generated signal to a computing device may be via wire extending from the flywheel enclosure 103.

Alternatively, a wireless communications system (e.g., BLUETOOTH®) enables transmission of the data from the optical sensor 204 to the computing device without wires. Where a wireless communications system is employed an internal power source (e.g., a small magnet and coil generator) may be placed at the very bottom of the flywheel enclosure 103, for example at an end of the bottom spindle segment 108. A fiberglass or other signal transmissive cover may also be incorporated to allow transmission of the wireless signal to the computing device. Further an internal computing device (not shown) may be incorporated into or associated with the optical sensor 204 such that position, diameter, vibration, and frequency data can be calculated and the calculated data, rather than the raw data is transmitted from the flywheel enclosure 103 to a computing device where the data may be analyzed and stored for future use.

In one aspect of the disclosure, the application stores in memory an initial signal (i.e., an initial radial dimension) of the flywheel 102. Over time, as the signal changes output from the optical sensor 204 changes, those changes in signal are associated with a change in radial dimension (e.g., diameter) of the flywheel 102. As noted above, due to the mass of the flywheel 102 and the speeds at which the flywheel is rotating, centrifugal forces acting on the flywheel will cause the material to creep over time, resulting in a change of diameter of the flywheel 102. The system described herein-above in connection with FIGS. 2 and 3 can measure that creep. Use of the optical sensor 204 can resolve the dimensions of the flywheel 102 in the order of 0.0001 inch. At some amount of dimensional change (i.e., creep) a material failure or contact with other components of the system 10 might occur, the application measuring the diameter of the flywheel 102 can signal for its shutdown to prevent the failure. Further, the application can provide regular reports on the changes in diameter during use of the flywheel 102.

Though depicted as just one optical sensor system 200, the disclosure is not so limited. Instead of just one sensor, two, three, four or more optical sensor systems 200 may be deployed within a single flywheel enclosure 103. For example, if two optical sensor systems 200 are deployed within a single flywheel enclosure 103. Each optical sensor system 200 may be located 180 degrees from the other (i.e., on an opposite side) of the flywheel enclosure 103. In this configuration, with at least two optical sensor systems 200, the creep of the material of the flywheel 102 can be confirmed. If there is a discrepancy between the output of the first optical sensor system 200 and the second optical sensor system, this can be interpreted by the application on the computing device as an imbalance or a vibration in the rotation of the flywheel 102. An appropriate indicator may be displayed on a user interface associated with the computing device and depending on the severity of the imbalance, the flywheel 102 may be stopped for servicing.

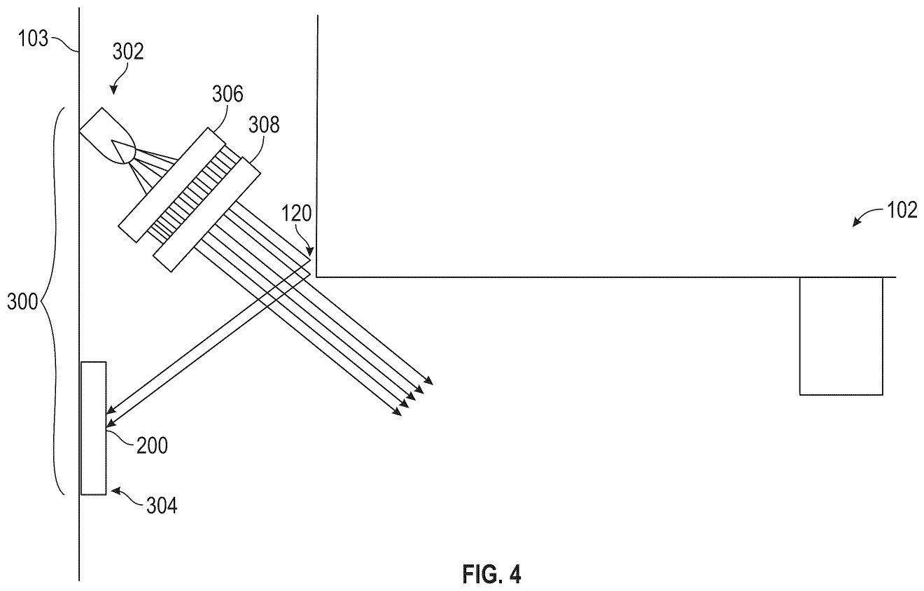

FIGS. 2 and 4 depict a further aspect of the disclosure. A second optical sensor system 300 is depicted mounted to the flywheel enclosure 103. The second optical sensor system 300 is substantially the same as optical sensor system 200. The main distinction is the orientation of the LED 302 and the optical sensor 304. As depicted with greater clarity in FIG. 4, the LED 302 and the optical sensor 304 are mounted parallel with a side surface of the flywheel 102. Operating in the same fashion as optical sensor system 200, described above, optical sensor system 300 is configured to measure any change in the vertical position or dimensions of the flywheel 102. Changes in the vertical or longitudinal dimension can be the result of creep, as described above, or alternatively may be the result of a change in status of the bearings supporting the flywheel 102. By having an optical sensor system 300 mounted to measure vertical changes of the flywheel 102 both at a top end of the flywheel 102 and a bottom of the flywheel 102 the application on the computing device can determine whether the entire flywheel 102 has moved vertically as might be the case if a bearing is showing signs of failure, or the result of creep of the material from which the flywheel is manufactured.

Though described herein in connection with creep detection, the disclosure is not so limited. The optical sensor system 200, 300 may be employed to assess one or more of whether an object is moving or changing in size, oscillating at a particular frequency, the magnitude of displacement, and assess historical records of edge or object movement. Further, and as noted above, the systems and methods described herein can be used to detect long term mechanical creep of a stressed structure (e.g., a spinning flywheel) for a determination of end-of-life or safe operating parameters. In one example, the data can be used in real time to cease operation of a system based on creep data.

The LEDs 202, 302 are also not limited to LED's but may any suitable light source including laser diodes, incandescent filament-based luminaries, and others suitable for the functions described herein. Illuminating the edges of the flat surfaces (e.g., the sides or bottom of the flywheel 102) enables the measurement of creep as well as vibration, harmonic motion, and the comparison of the motion of the two ends (top and bottom) of a flywheel. As will be appreciated, temperature data may be received by the application (e.g., via a touchless thermal detector directed at the flywheel 102) and analyzed by the application to account for the size change of an object due to thermal expansion.

In addition, as noted above, shaped or cylindrical lenses, polarizing materials, and interference filters that only allow the intended light source wavelength to pass through to be reflected on to the optical sensor 204, 304 may be used in accordance with the disclosure. In yet a further aspect, an initial optical polarizer could be inserted on or near the LED 202, 302 and a secondary polarizer can be mounted over the optical sensor 204, 304 to eliminate reflected light that misses the target edge or background light in general. Still further, an optically spectral target surface will allow the reflected beam to maintain a good percentage of its initial polarization.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. An optical sensor system comprising:
a light source configured to illuminate an edge of a rotating element;
a light filter optically between the light source and the edge of the rotating element;
an optical sensor configured to detect light reflected from the edge of the rotating element, wherein the optical sensor outputs a signal indicative of a location of the edge of the rotating element.

2. The optical sensor system of claim 1, further comprising a lens configured to focus the light emitted from the light source.

3. The optical sensor system of claim 1, wherein the light source is a light emitting diode.

4. The optical sensor system of claim 1, further comprising a polarizer on the light source.

5. The optical sensor system of claim 1, further a polarizer on the optical sensor.

6. The optical sensor system of claim 1, wherein the optical sensor includes an array of photo-receptors.

7. The optical sensor of claim 6, wherein the array of photo-receptors comprises a series of rows of photo-receptors.

8. The optical sensor of claim 7, wherein each row of photo receptors is spaced less than about 10 microns a neighboring row of photo-receptors.

9. The optical sensor of claim 7, wherein the array of photo-receptors can resolve a change in dimension of the rotating element of about 0.0001 inch.

10. The optical sensor system of claim 1, wherein the rotating element is a flywheel.

11. The optical sensor system of claim 10, further comprising a computing device including a memory storing therein instructions that when executed by a processor perform a step of determining a difference between the signal output from the optical sensor to an initial signal, wherein the difference is indicative of a change in radial dimension of the flywheel.

12. The optical sensor system of claim 11, wherein the memory stores therein instructions which when executed by the processor perform a step of stopping rotation of the flywheel when the difference indicative of a change in a longitudinal dimension of the flywheel is in excess of a threshold.

13. The optical sensor of claim 10, further comprising a computing device including a memory storing therein instructions that when executed by a processor performs a step of determining a difference between the signal output from the optical sensor to an initial signal, wherein the difference is indicative of a change in longitudinal dimension of the flywheel.

14. The optical sensor system of claim 13, wherein the memory stores therein instructions which when executed by the processor perform a step of stopping rotation of the flywheel when the difference indicative of a change in the longitudinal dimension of the flywheel is in excess of a threshold.

15. An energy storage system comprising:
a motor;
a flywheel operatively coupled to the motor and including a flywheel enclosure; and
an optical sensor system mounted within the flywheel enclosure, the optical sensor system including:
a light emitting diode (LED) configured to illuminate an edge of the flywheel;
a light filter optically between the LED and the edge of the flywheel;
an optical sensor configured to detect light reflected from the edge of the flywheel, wherein the optical sensor outputs a signal indicative of a location of the edge of the flywheel.

16. The energy storage system of claim 15, further comprising a computing device including a memory storing therein instructions that when executed by a processor perform a step of determining a difference between the signal output from the optical sensor to an initial signal, wherein the difference is indicative of a change in radial dimension of the flywheel.

17. The energy storage system of claim 16, wherein the memory stores therein instructions which when executed by the processor perform a step of stopping rotation of the flywheel when the difference indicative of a change in a longitudinal dimension of the flywheel is in excess of a threshold.

18. The energy storage system of claim 15, further comprising a computing device including a memory storing therein instructions that when executed by a processor performs a step of determining a difference between the signal output from the optical sensor to an initial signal, wherein the difference is indicative of a change in longitudinal dimension of the flywheel.

19. The energy storage system of claim 18, wherein the memory stores therein instructions which when executed by the processor perform a step of stopping rotation of the flywheel when the difference indicative of a change in the longitudinal dimension of the flywheel is in excess of a threshold.

20. The energy storage system of claim 15, further comprising a second optical sensor system including:
a second light emitting diode (LED) configured to illuminate an edge of the flywheel;
a second light filter optically between the LED and the edge of the flywheel;
a second optical sensor configured to detect light reflected from the edge of the flywheel, wherein the optical sensor outputs a signal indicative of a radial dimension of the flywheel and the second optical sensor outputs a signal indicative of a longitudinal dimension of the flywheel.
